(19) United States
(12) Patent Application Publication
(10) Pub. No.: US 2007/0204437 A1
(43) Pub. Date: Sep. 6, 2007

(54) Folding assist handle assembly

(76) Inventors: Richard Hartmann JR., Holland, MI (US); Richard J. Camarota, Holland, MI (US)

Correspondence Address: FLYNN THIEL BOUTELL & TANIS, P.C., 2026 RAMBLING ROAD, KALAMAZOO, MI, 49008-1631, US

(21) Appl. No.: 11/366,307

(22) Filed: Mar. 1, 2006

(51) Int. Cl. H01M 2/10

(52) U.S. Cl. 16/444

(57) ABSTRACT

A folding assist handle assembly for mounting on a surface has a handle that is resiliently biased to lie in either of two detented positions: a stowed position adjacent the surface and a use position projecting away from the surface. The detents are configured so that the handle can be moved out of its stowed position simply by a lateral pull with a first force, where as moving the handle out of its use position by a later pull requires an upward force in addition to a circumferential force. A two-sided access cover for the assembly's base member is useful for assembly, repair, adjustment, and implementation of accessories.

### FIELD OF THE INVENTION

This invention relates to a folding assist handle assembly, and more particularly to one having alternative use and stowed positions.

### BACKGROUND OF THE INVENTION

It is well known to provide assist handle assemblies on fixed surfaces and for people to grasp same to steady themselves. For example, vertical assist handle assemblies are often fixed adjacent the entry/exit doorway of motor homes, travel trailers, semi-truck tractors and the like to steady a person as he/she walks up one or several steps to reach the doorway and enter the vehicle. Such an assist handle assembly also steadies a person as he/she exits the vehicle through the doorway and steps downward to the ground. A purpose is to help steady a person as would the usual banister or stair rail which flanks a stairway in a building or leading from the ground to a porch, but wherein such a fixed banister or railing projecting outward from the side of a vehicle would impermissibly interfere with normal travel of the vehicle along a road.

Some vehicles carry fixed assist handle assemblies of shallow U-shape wherein the hand graspable bight portion is permanently fixed to the side of the vehicle and projects out sidewardly from the vehicle only sufficient to enable gripping by the hand of the user. Such fixed, shallow assist handle assemblies may suffice for vehicles wherein the doorsill is a single short step up from the ground, as for a small, low slung travel trailer, or wherein steps are notched ladder-like in the sidewall of the vehicle, as in some semi-truck tractors. The assignee of the present invention markets several such shallow U-shaped assist handle assemblies, including one disclosed in U.S. Pat. No. 6,592,240, wherein the hand graspable bight portion is of light transmitting material and internally illuminated to help a person find same easily in the dark.

However, some vehicles may have a doorsill higher off the ground and reachable by climbing one or several steps, for example a step unit temporarily seated on the ground adjacent the doorway, or steps normally stowed beneath a vehicle and capable of being pulled outward to a use position. In such instance, a shallow U-shaped rigid assist handle assembly may be hard to reach from the bottom of the steps and it may be preferred to have the hand graspable portion of the assist handle spaced substantially further from the sidewall of the vehicle, so as to be readily graspable by a person mounting a step spaced a foot or two or more from the side of the vehicle or a person descending from the vehicle by use of such step or steps. To this end, folding assist handle assemblies have a use position in which the hand graspable portion is spaced a considerable distance from the side of the vehicle, typically between one and three feet, to steady a person ascending or descending the stair or stairs, and a stowed position swung close against the side wall of the vehicle, so as not to interfere with vehicle road travel.

One known folding assist handle assembly comprises a substantially straight bar hinged at its top to the vehicle sidewall and connected adjacent its bottom, by a folding link pivoted on a lower portion of the vehicle sidewall. Such a bar has a use position angled outwardly and downwardly from its hinged top and with its lower end spaced from the vehicle sidewall by temporary fixing of its folding link in a straight, elongate position. Such a bar is returned to its stowed position by folding the foldable link to enable the bottom of the hand graspable portion to closely approach the sidewall of the vehicle. Disadvantageously, the user may find it cumbersome and time consuming to shift and fix the folding link in its alternative straight and folded positions, and may risk pinching a finger while folding the folding link into its stowed position.

Other known folding assist handle assemblies are characterized by an elongate, relatively deep, U-shaped, hand graspable handle whose ends are vertically spaced and pivotally supported for horizontal swinging movement by coaxially aligned base units fixed on a side of the vehicle. The pivoted ends of the U-shaped handle are loaded by springs downward to stay fixed in either a detented, projecting use position or a detented stowed position closely adjacent the vehicle sidewall. In such folding assist handles of which we are aware, the user must vertically lift an end of the U-shaped handle, against the downward force of the springs, to remove the hand graspable element from both its detented used position and its detented stowed position. To overcome a substantial downward spring force, an entry-seeking-user may have to interrupt his approach to the stairs, and step around the stairs to the vehicle sidewall where the handle is pivoted, then lift the upper and/or lower arm end of the U-shaped handle out of its detented stowed position to enable laterally swinging the hand graspable handle away from the vehicle sidewall and toward its use position. The user can then let go of the arm end of the handle, step back around to the bottom of the stairs and only thereafter grasp the upstanding bight of the handle and mount the stairs. Such prior handle assemblies are inconvenient to use.

An example of such a folding grab handle is shown in Brammer et al., U.S. Pat. No. 4,976,455, assigned to Stromberg-Carlson Products, Inc.

Another example fixes, to each of the top and bottom ends of the handle, a laterally pivotable member having four elongate depending fixed pins received in the corner portions of a square depression in the top of a base member fixed to the vehicle sidewall. The depending pins and square depression are arranged around a central, vertical pivot bolt, spring loaded from below to forcibly hold the pins downward in the depression. Thus, as with the Brammer et al. device above mentioned, to swing the hand graspable handle from its stowed position requires the user to simultaneously (1) maintain a lifting force sufficient to keep the pins spaced above the rectangular depression and (2) horizontally swing the hand graspable portion away from the sidewall of the vehicle.

Another example has its relatively pivoted parts are formed of metal sheets or plates that are respectively fixed to the ends of the arms of the handle and to the vehicle sidewall.

### SUMMARY OF THE INVENTION

In one embodiment of the invention, a folding assist handle assembly for mounting on a surface is resiliently biased to lie in a stowed position adjacent such surface, but can be pivoted out of its stowed position simply by a lateral pull into a projecting use position, and is pivotable from its use position by lifting from against a resilient force and lateral pushing.

In a further embodiment of the invention, a folding handle assembly includes a first member fixedly mountable on a surface and a second member pivotally supported thereon and fixed to an end of a hand engageable handle, wherein one of the first and second members has a relatively short projection with camming surfaces and the other of the first and second members has circumferentially spaced shallow and deep depressions for alternatively receiving the projection in stowed and use positions, respectively, of the folding handle.

In a further embodiment of the invention, a folding handle assembly includes a base member fixedly mountable on a surface for pivotally supporting a hand engageable handle and including an accessory device, for example a light source illuminating the handle member in at least one of its stowed and use positions.

In a further embodiment of the invention, a folding handle assembly includes a base member fixedly mountable on a surface for pivotally supporting a hand engageable handle, the base member having an access cover that provides access to two orthogonal sides thereof.

Further aspects of the invention will be apparent to persons acquainted with the apparatus of this general type upon reading the following description and viewing the attached drawings.

### BRIEF DESCRIPTION OF THE DRAWINGS

FIG. 1 is a pictorial view of a folding assist handle assembly embodying the present invention and in its use position.

FIG. 1A is a fragmentary schematic plan view of FIG. 1 handle assemblies installed on support surfaces on opposite sides of a stairway and entrance doorway.

FIG. 2 is an enlarged fragment of FIG. 1.

FIG. 3 is a fragmentary pictorial view of the base and rotor members of FIG. 2, showing a back side of the base member.

FIG. 4 is a fragmentary pictorial view of the base and rotor members of FIG. 2, with the access cover removed to clearly show internal structure.

FIG. 5 is an exploded view of the base and rotor members of FIG. 2, with the detents omitted for convenience in illustration.

FIG. 6 is a pictorial view of the FIG. 2 base member with the access cover removed.

FIG. 7 is a top plan view of the base member of FIG. 6.

FIG. 8 is a central cross-sectional view substantially taken on the line 8-8 of FIG. 7.

FIG. 9 is a cross-sectional view substantially taken on the line 9-9 of FIG. 7.

FIG. 10 is a pictorial view of the access cover of FIG. 2.

FIG. 11 is a sectional view of the base member, including the access cover, substantially taken on the line 11-11 of FIG. 12.

FIG. 12 is a sectional view of the base member, similar to FIG. 8, but including the access cover.

FIG. 13 is a pictorial view of a rotor member of FIG. 1.

FIG. 14 is a top view of the rotor member of FIG. 1.

FIG. 15 is a sectional view of the rotor substantially taken on the line 15-15 of FIG. 16, with a portion in relief.

FIG. 16 is a bottom view of the rotor member of FIG. 13.

FIG. 17 is a fragmentary, partially broken side elevational view of the apparatus of FIG. 2 with the rotor member and handle in use position.

FIG. 18 is a view similar to FIG. 17, but with the rotor member and handle in stowed position.

FIG. 19 is a fragment of FIG. 17 but with the rotor member and handle rotated to a position intermediate their FIG. 17 use and FIG. 18 stoned positions.

### DETAILED DESCRIPTION

Certain terminology will be used in the following description for convenience in reference only and will not be limiting. The words “up,” “down,” “right” and “left” will designate directions in the drawings to which reference is made. The words “in” and “out” will refer to directions toward and away from, respectively, the geometric center of the device and designated parts thereof. The words “proximal” and “distal” will refer to the orientation of an element with respect to the device. Such terminology will include derivatives and words of similar import.

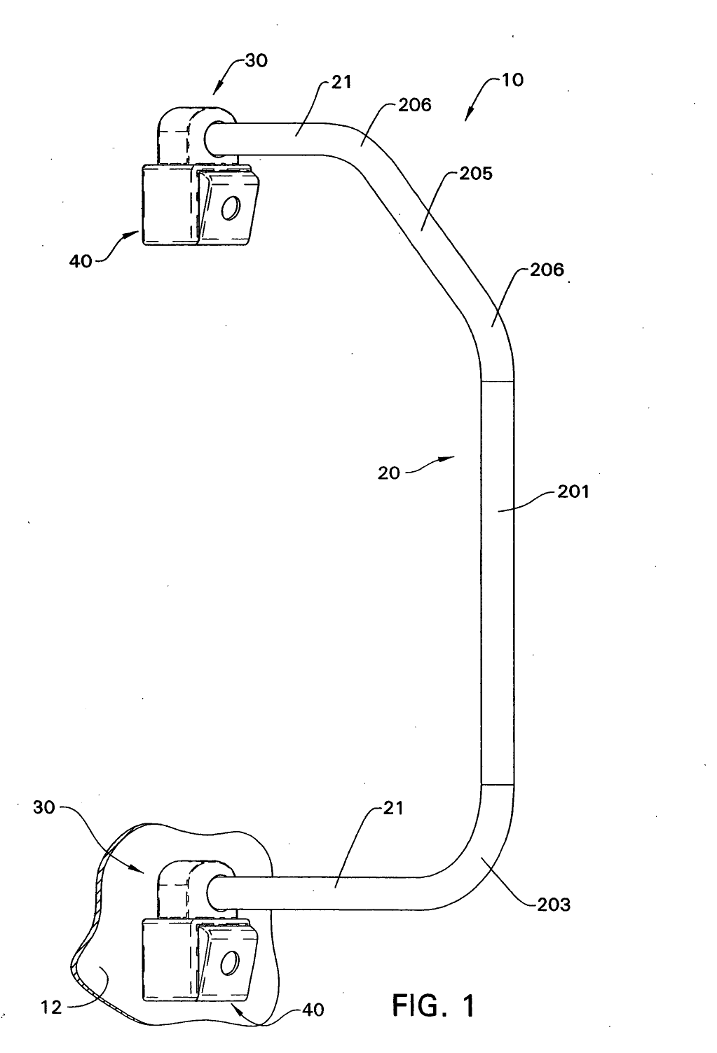

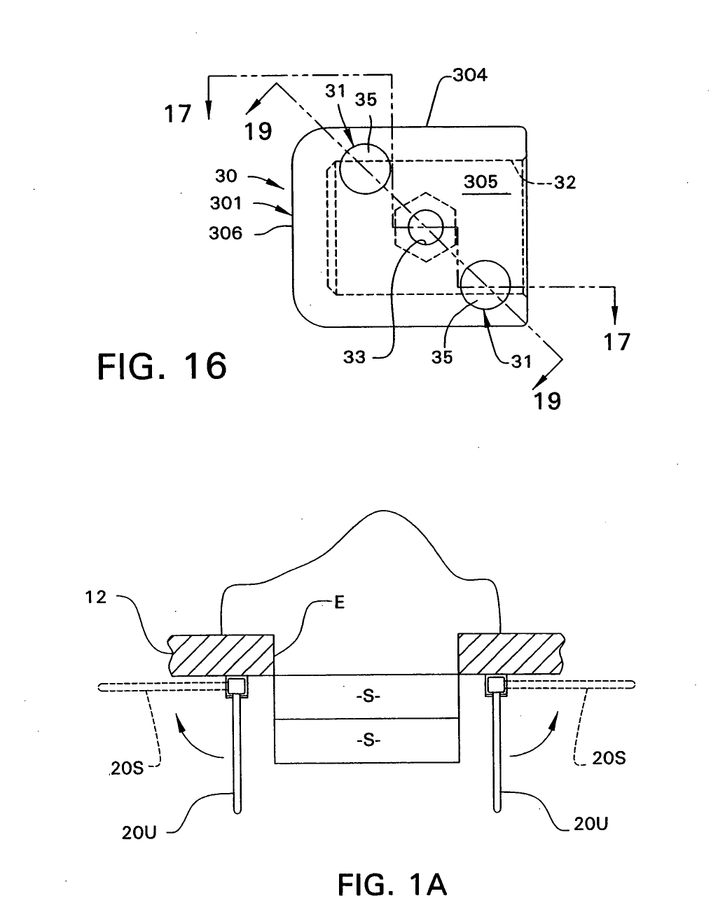

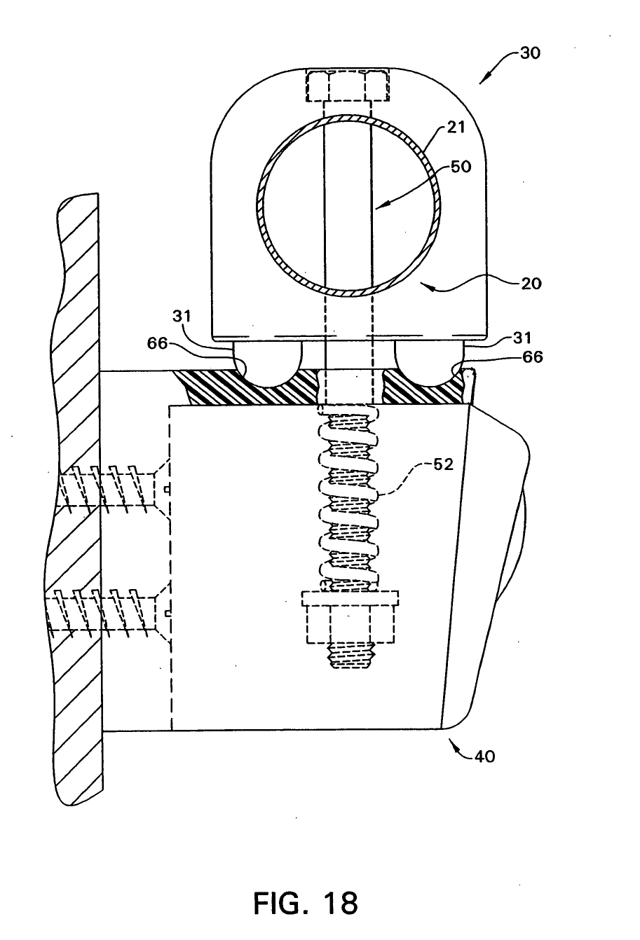

A folding handle assembly 10 (FIG. 1) embodying the invention has a generally U-shaped handle 20, rotor members 30 fixed to the ends of the handle 20, and a pair of base members 40 rotatably supporting corresponding ones of the rotor members 30 on a desired support surface (e.g., a vehicle exterior sidewall) 12, for displacement between a detented use position (FIGS. 1-4 and 17) and a detented stowed position (FIG. 18).

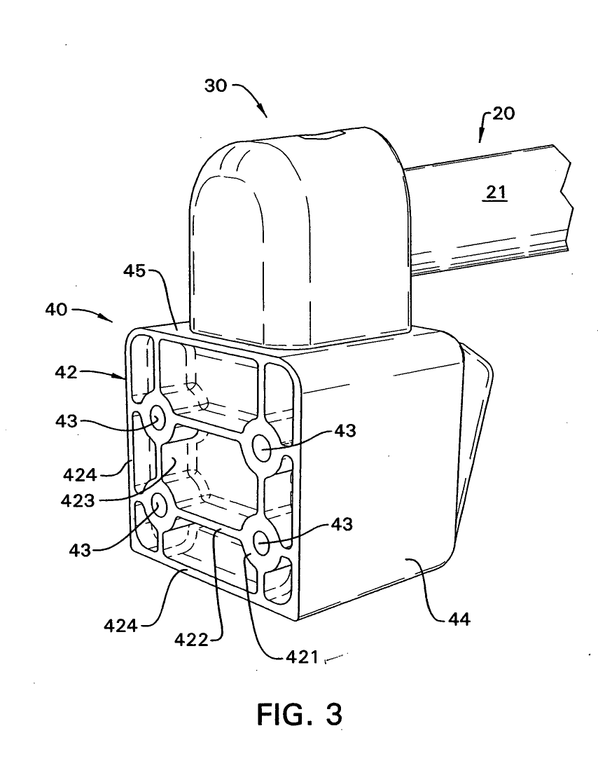

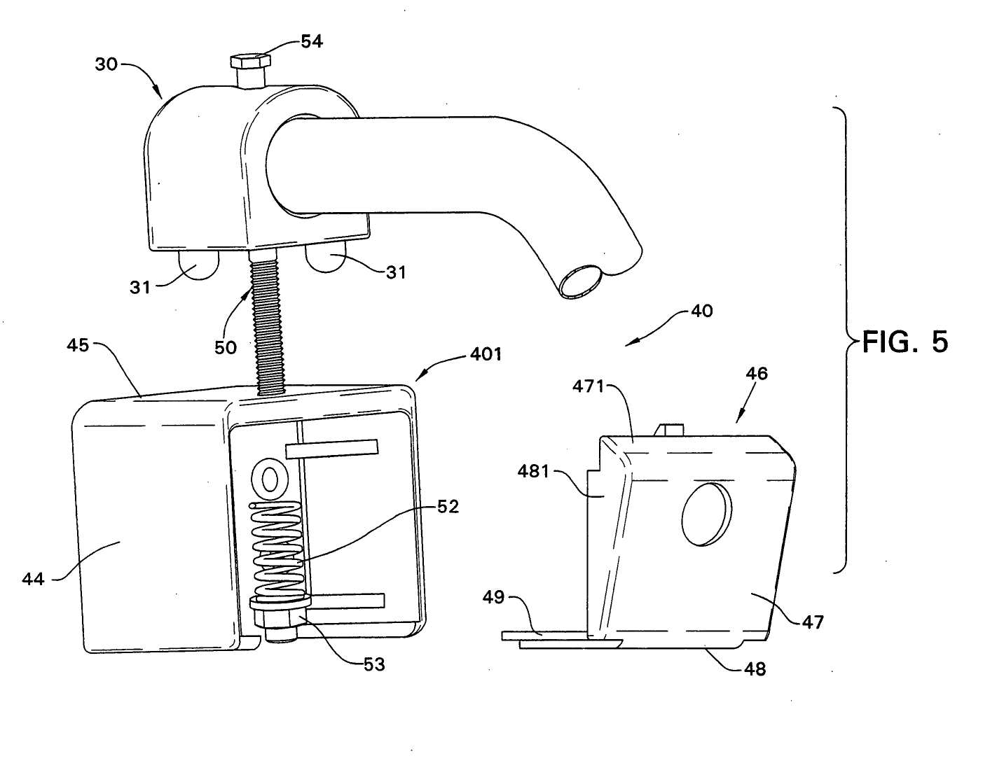

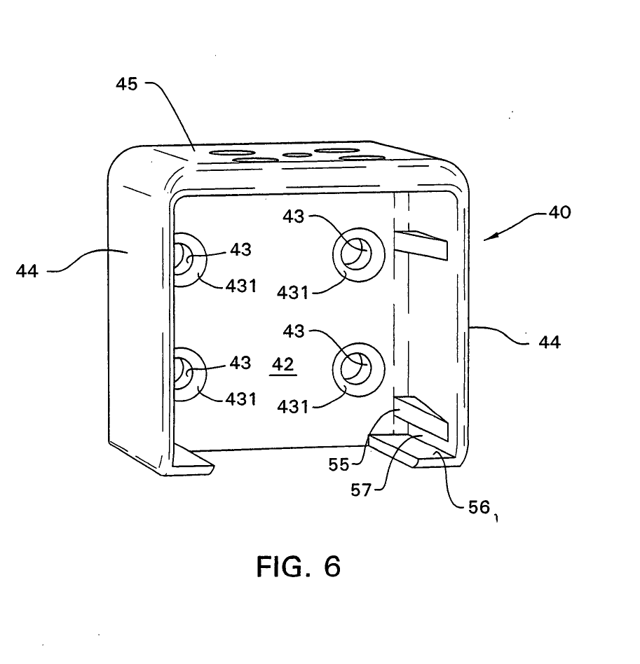

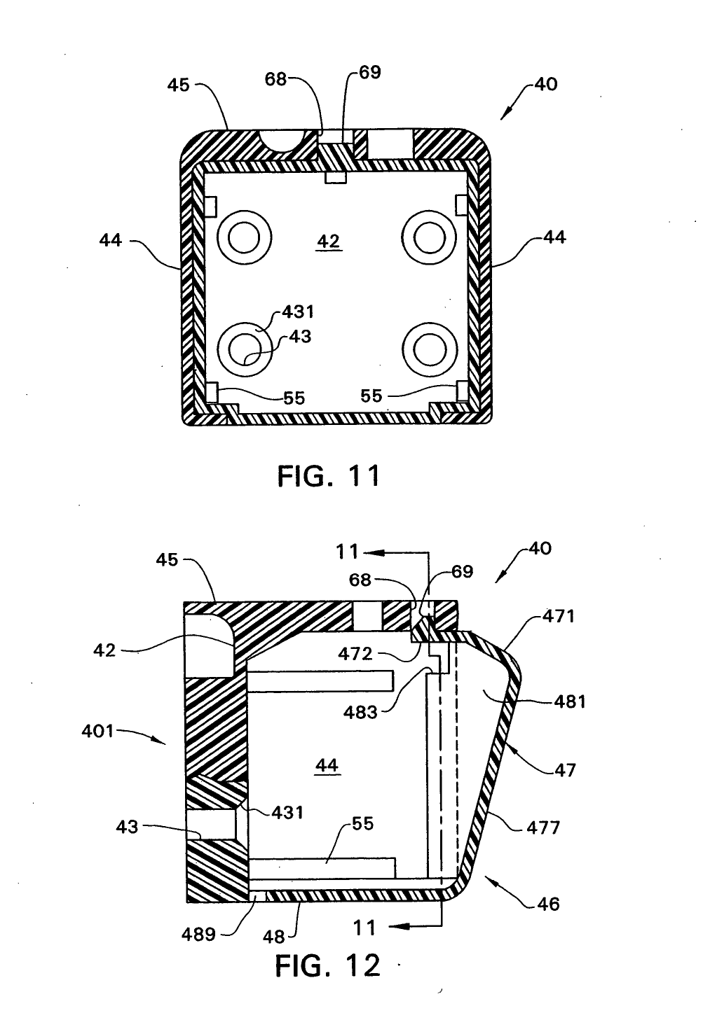

The base members 40 may differ from each other but are preferably identical for manufacturing and inventory convenience. The base member 40 (FIGS. 3-9 and 10-12) comprises a box-like housing 401 which includes a back wall 42 (FIG. 3), two side walls 44 and a top wall 45. Mounting holes 43 open through the back wall 42. The mounting holes 43 are preferably countersunk 431 (FIGS. 6, 8, 9, 11 and 12) at the inside surface of the back wall 42.

The base member housing back wall 42 has rearward facing release to avoid waste of material while providing adequate rigidity by means of rearwardly extending bosses coaxial 421 coaxially surrounding the mounting holes 43 and horizontal webs 422 and vertical webs 423 (FIG. 3) connecting the bosses 421 to each other and to the rearward extending peripheral edge portions 424 of the back wall 42.

The base member housing side walls 44 extend forward in substantially parallel relation from side edges of the back wall 42. Buttresses 55, preferably of narrow triangular plan, are based adjacent the side edges of the back wall 42 and taper forward nearly to the front edges of the side walls 44 (FIG. 6). The buttresses 55 are vertically spaced, the top buttress 55 being spaced downward from the housing top wall 45 and the bottom buttress 55 being spaced above the bottom of the corresponding side wall 44. A substantially rectangular lip 56 extends the length of the lower edge of each sidewall 44 and a short distance along the bottom edge of the back wall 42, the lips 56 being spaced by the major width of the back wall 42. Each bottom buttress 55 is spaced some what above its corresponding lip 56 to define a forwardly extending inboard facing channel 57.

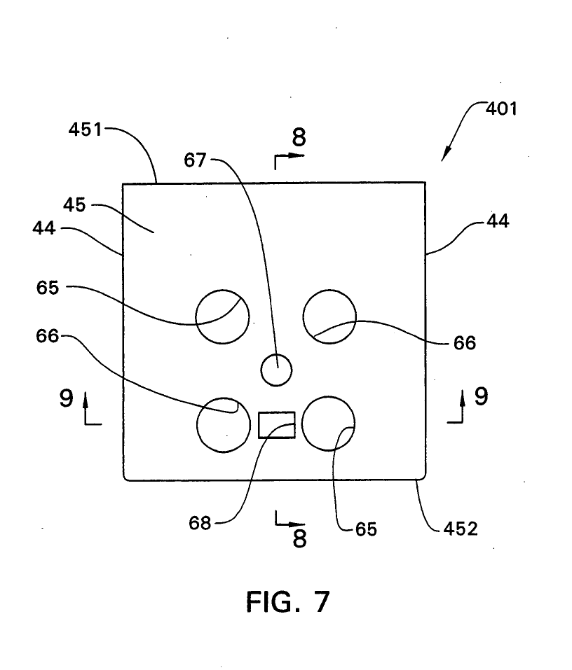

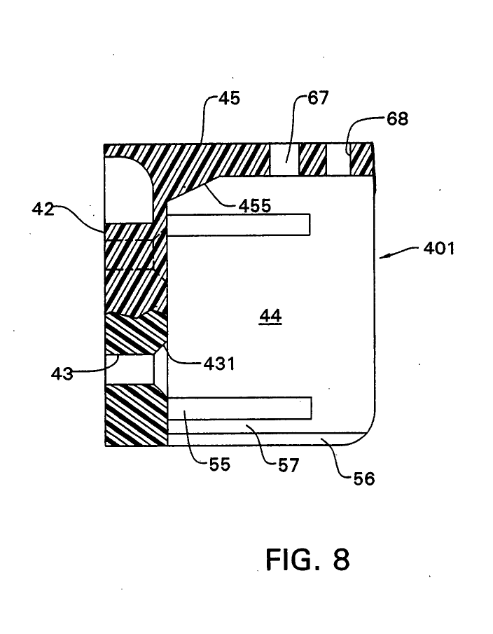

The base member housing top wall 45 (FIGS. 6-9) has a pivot bolt hole therethrough which is centered between the side walls 44 is offset forwardly so as to lie closer to the top wall front edge 452 then to its back edge 451. In the particular embodiments shown, the hole 67 is located about ⅝ of the way forward from the back edge 451. In the embodiments shown in FIGS. 7-9, the front edge of the top wall 45 extends slightly beyond (e.g. 5-6%) the front edge of the side walls 44 and is preferably convexly rounded in profile as seen in FIG. 8.

Detents 65, 66 (FIG. 7) in the top wall 45 have axes equally circumferentially spaced from each other and at the same radial distance from the axis of the pivot hole 67. In the embodiments shown, the deep detents 65 are diagonally imposed on opposite sides of the pivot hole 67 at a spacing at about ½ the width of the top wall 45, and the same is true of the shallow detents 66. In the embodiments shown, the top wall 45 is preferably about 10 to 12% wider than the front/rear distance between its back edge 451 and front edge 452.

The detents 65 and 66 are hereafter referred to as deep and shallow detents respectively. In one unit constructed according to the invention, the deep detents were through holes of about 0.38 inch diameter, chamfered at the top with a diameter of about 0.44 inch, and the shallow detents 66 were hemispherical recesses of about 0.1875 inch radius (about 0.375 diameter), and thus closely approaching the diameter of the deep detents.

A retention, or latch, hole 68, here of laterally elongate substantially rectangular cross section is preferably centered between the front most detents 65 and 66 and here has a central axis substantially coplanar with the central axis of the front most detents 65 and 66.

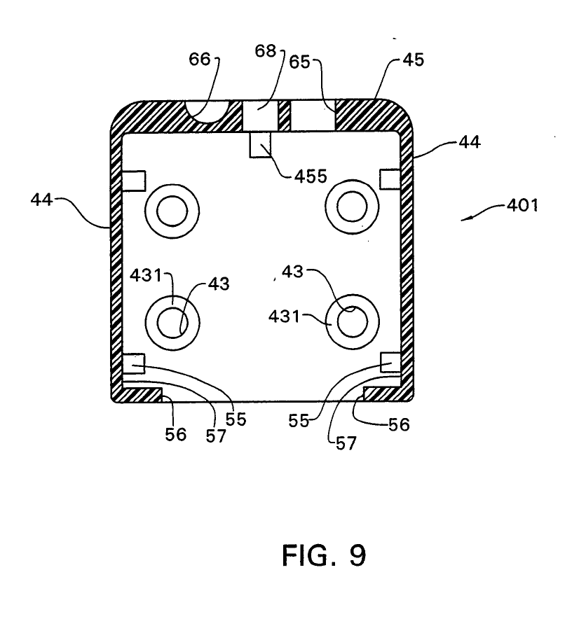

A small, triangular profile, buttress 455 (FIGS. 8 and 9) extends forward from the back wall 42 and is preferably centered on the underside of the top wall 45. In the embodiments shown, the forward/rearward extent of the buttress 455 is about the same as the thickness of the back wall 42 and the vertical extent of the buttress 455 is about the same as the thickness of the top wall 45. In the embodiments shown, the back wall 42 is about twice the thickness of the top wall 45 which in turn is about 2 to 3 times the thickness of the side walls 44 and lips 56.

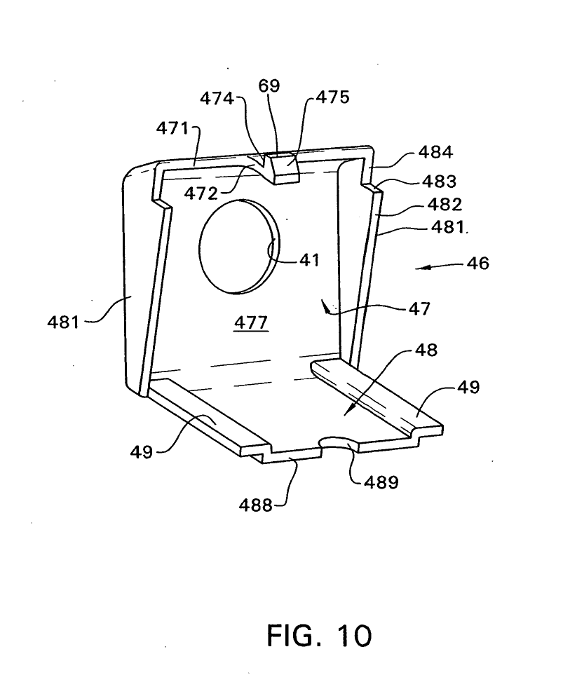

Each base member 40 preferably includes an access cover 46 (FIGS. 5, 10-12 and 17). The access covers 46 are preferably identical, for convenience in manufacturing and inventory maintenance. Each access cover 46 comprises a bottom wall 48 having side edge portions stepped up to form laterally extended flanges 49 extending the full forward/rearward length of the bottom wall 48. The accessory cover 46 further includes a front wall 47 generally upstanding from the front edge of the covered bottom wall 48 and preferably sloped somewhat forwardly as generally indicated in FIG. 12. The front wall 47 includes a top portion 471 which slopes upward and rearward. A narrow central tab 472 extends rearward from the covered top portion 471 and at its rear edge portion carries an upstanding catch lip 69 having an upstanding front face 474 and a rearwardly and upwardly beveled rear face 475. The upward and forward sloping portion 477 of the cover front wall 47 may be closed as generally indicated in FIG. 12, but preferably is providable with a laterally centered somewhat upwardly offset accessory hole 41 (FIG. 10) which may be initially open as indicated in FIG. 10 or, it is contemplated, may be provided with a knock-out plug (not shown) so as to either serve as a closed front wall or as a front wall capable of mounting an externally visible accessory device, as hereafter discussed.

The cover 46 further includes relatively narrow sidewalls 481 extending rearward from the side edges of the front wall 47 and upstanding from the rear portions of the upward edges of the flanges 49. The rear edges 482 of the sidewalls 481 are preferably substantially vertical with their upper rear portions are stepped as indicated at 483, here at about the level of the transition from the front wall lower portion 477 and upper portion 471. The sidewall 481 above the step 483 has a forwardly offset rearward facing edge 484 preferably coplanar with the rear edge of the top portion 471 of the front wall top portion 47. The rear edge 488 of the covered bottom wall 48 preferably includes a rear opening, here semicircular, centrally located finger notch 489 to facilitate removal of the cover 46 from the base member housing 401 as hereafter discussed.

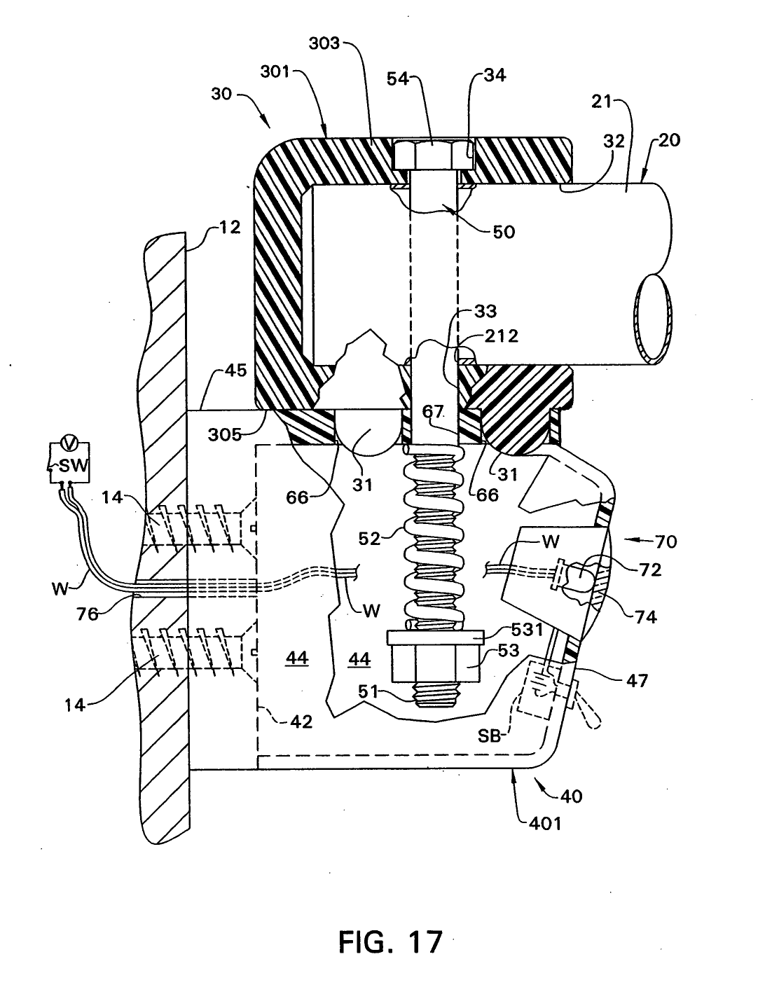

Fasteners (here screws) 14 (FIGS. 17 and 18) extend through the holes 43 to fasten the base member 40 to the support surface 12.

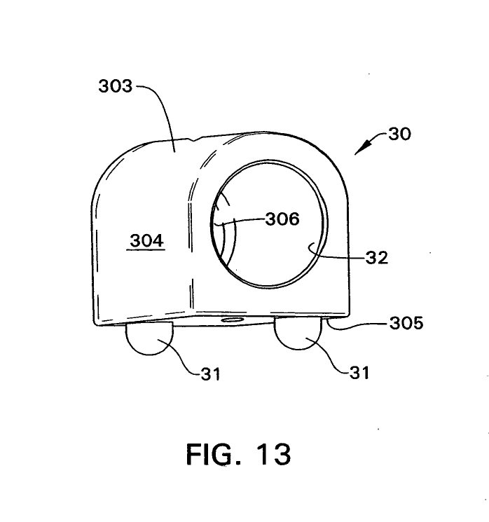

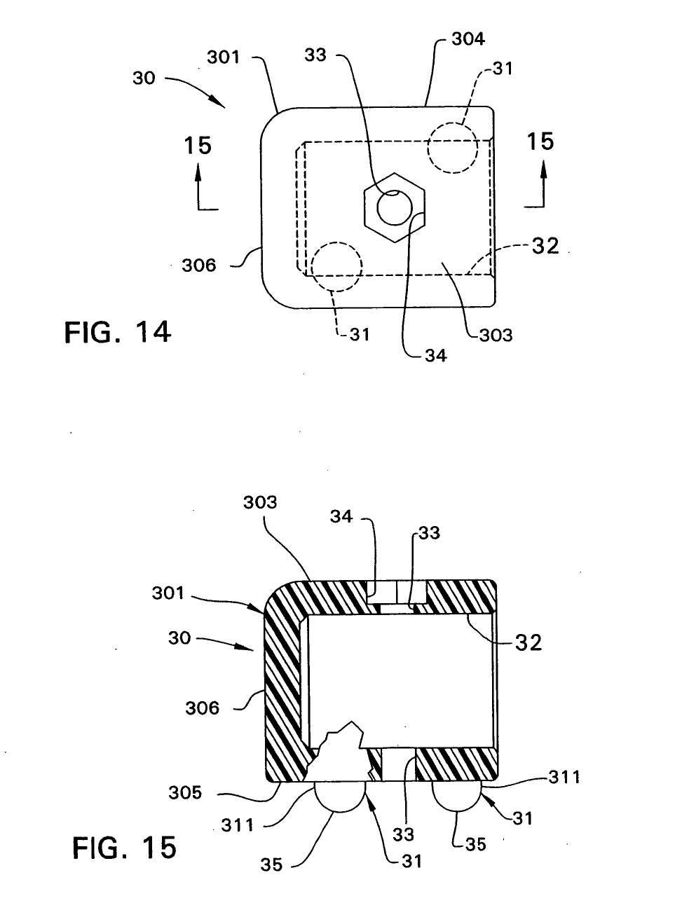

The rotor members 30 are preferably identical, for convenience in manufacturing and inventory maintenance. Each comprises a generally rectilinear body 301 (FIG. 13) preferably having a cylindrically rounded, convex top wall 303, upstanding sidewalls 304 and a bottom wall 305 as well as an upstanding back wall 306. The major portion of the body 301 is hollowed out to form a forward opening cylindrical, preferably circular cross section recess 32. A pivot bolt hole 33 has vertically through the top and bottom walls 303 and 305 (FIGS. 14-16), and is located so that its length axis and the length axis of the recess 32 are substantially coplanar. The pivot hole 33 is preferably located about half way along the axial depth of the recess 32. The hole 33 opens upward through the top wall 303 by means of an enlarged, preferably hexagonal counter bore 34.

A pair of projections 31 depend from the bottom wall 305 and are evenly diametrically spaced from the pivot hole 33 at the spacing above described with respect to the base member shallow detents 66 with respect to the base member pivot hole 67 (and the base member deep detents 65 with respect to the base member pivot hole 67). The projections 31 have their length axis in a plane lying in a 45 degree angle with respect to the plane of the axis of the rotor member pivot bolt hole 33 and recess 32, as the same manner of the detent pair 65 (and detent pair 66) with respect to a plane including the longitudinal axis of the pivot hole 67 and parallel to the side walls 44 of the base member housing 401.

The projections 31 each comprise a shallow circularly cylindrical base 311 terminating in a preferably hemispherical, convex downward facing end 35. The diameter of the base 311 and radius of the end 35 preferably are respectively a clearance fit with the deep detents 65 and the same as the radius of the shallow detents 66. In one unit constructed according to the invention, the plate of the base 311 was about 0.06 inch and the radius of the hemispherical end 35 was about 0.187 inch, providing a total height of the projection 31 of about 0.247 inch.

The handle 20 is preferably a rigid relatively light weight (e.g. aluminum) tube that to the manner shown in FIG. 1, namely with a central hand grip 201, which may conveniently be provided with a suitable friction grip surface (texturing or a rubber-like sleeve for example). The handle 20 in its FIG. 1 orientation aligns the central hand grip vertically. The handle 20 includes end portions 21 which in FIG. 1 are oriented horizontally. The end portions 21 are coplanar. One end portion (the lower one in FIG. 1) connects to the central hand grip through a rounded right angled bent portion 203. On the other end portion 21 connects to the opposite end of the central hand grip 201 preferably through an angled (preferably 45 degree) portion 205 terminating in 45 degree, gradually bent transition portions 206. The ends 21 (FIG. 17) of the handle 20 are of diameter to telescope snuggly but slideably in the recess 32 of the body 301 of either rotor member 30. Each handle end portion 21 has a diametrical through hole 212 whose central axis is coplanar with the plane of the central axis of the handle 20 and which is spaced from the free end of the end portion 21 so as to be coaxial with the pivot bolt hole 33 of the rotor body 301 when the handle end portion 21 is fully telescoped within the rotor member body recess 32, as seen in FIG. 17.

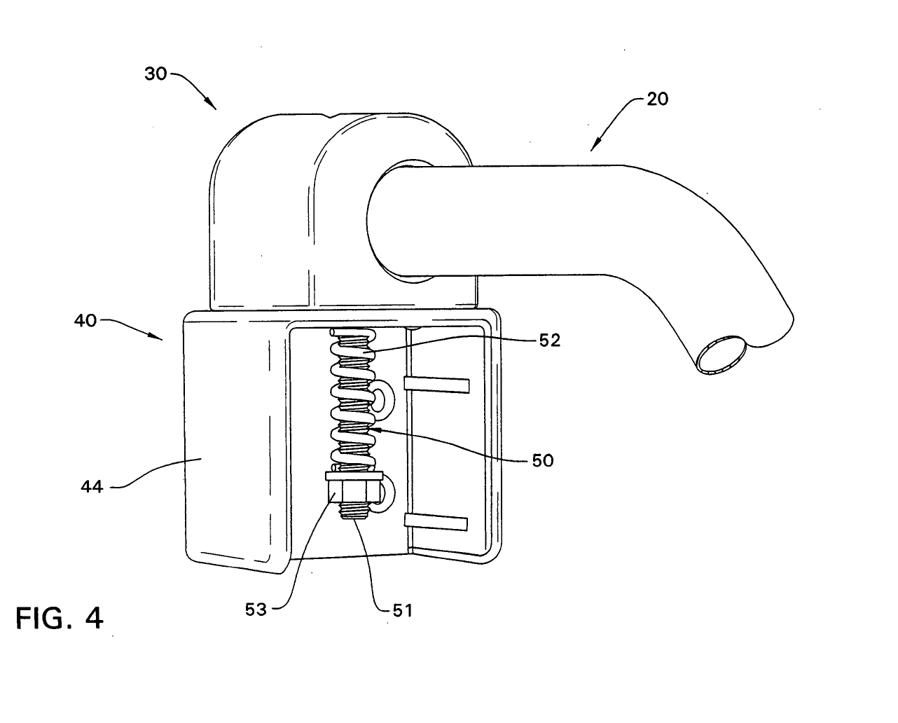

The handle assembly 10 further includes an elongate pivot bolt 50 (FIG. 17). The pivot bolt 50 (FIGS. 4, 5 and 17) is preferably a conventional unit comprising a hexagonal head 54 sized to fit snuggly, slideably and non-rotatably in the hexagonal counter bore 34 of the rotor body 301, a shank 51 sized to snuggly but slideably extend through the handle end holes 212, the rotor body holes 33 and a base member housing hole 67. The bolt shank 51 loosely telescopingly receives an elongate coil compression spring 52 retained by a conventional washer 531 and nut 53.

### Assembly

To assemble one end (e.g. upper end in FIG. 1) of the handle assembly, the corresponding end portion 21 (FIG. 17) of the handle 20 is inserted coaxially into the adjacent rotor body 301 such that the holes 212 and 33 thereof are coaxially aligned. The corresponding base member housing 401 is then moved up against the rotor 30, with the housing top wall 45 against the rotor bottom wall 305, the rotor projections 31 received in the deep detents 66 and the housing pivot bolt hole 67 coaxially aligned beneath the rotor pivot bolt hole 33. The shank 51 of the bolt 50 is then inserted downward through the thus coaxially aligned pivot bolt holes 33, 212 and 67 so as to pass downward through the rotor body 301 and handle end portion 21 and the top wall 45 of the base member housing 401 so as to align the space between the base member housing side walls 44 and the bolt head 54 seated in the hexagonal counter board 34 in the rotor body top wall 303.

With the access cover 46 absent, the interior of the base member housing 401 is readily accessible (FIG. 4), as is the lower end of the shank 51 of the bolt 50. The spring 52 is then telescoped upward onto the bolt 50, followed by the washer 531. The spring 52 is then pressed against the inside surface of the top 45 of the base member housing 401 by threading the nut 53 onto the free, bottom end of shank 51 of the bolt 50. This combination of spring biases the rotor member 30 downwardly against the top 45 of the base member housing 401.

The amount of biasing force the spring 52 provides is increased or decreased by threadedly tightening or loosening the nut 53 on the bolt 50 to achieve a desired biasing force.

With the corresponding rotor members 30 and base members 40 thus installed on the top and bottom end portions of the handle 20, the handle assembly 10 may be installed on a desired support surface 12 as follows. Upon positioning the handle assembly 10 on the support surface 12 at the location and in the orientation desired, the screws 14 are inserted rearwardly through the mounting holes 43 in the back wall 42 of the base member housing 401 (FIG. 17) and threaded into the support surface 12 and tightened to rigidly fix the base members 40 to the support surface 12. As shown in FIG. 1, the handle 20 is normally oriented in a vertical plane. However, it is contemplated that other orientations are possible, for example in a plane sloped to the vertical or on a support surface which is not upstanding, (as in FIG. 1) but rather sloped upward or downward facing (e.g. a floor or overhead). The usual application to which the inventive handle assembly 10 is directed is mounting on a vertically or substantially vertical wall 12 as in FIG. 1, and normally with the plane of the handle substantially vertical. Moreover, the rotors 30 are normally disposed atop their respective base members 40 in that the user normally applies his/her weight downward (rather than upward), as climbing or descending stairs next to which the handle assembly 10 is installed, and the downward application of the users weight on the handle 20 tends to force the rotors 30 downward against the base members 40 to thereby assist the corresponding springs 52 and holding the projections 31 in, and against upward escape from, there corresponding deep detents 65 (FIG. 17).

With the base member housing thus fixed to the environmental support surface 12, each access cover 46 (FIGS. 5, 10-12 and 17) is then slid rearwardly between the sides 44 of its corresponding base member housing 401. The channels 57 formed at the lower inside surfaces of each side 44 of a given base member housing 401 between the lips 56 (FIGS. 6, 8 and 9) and lower buttresses 55, each slidingly accepts a corresponding flange 49 (FIGS. 5 and 10) of the access cover 46.

As the access cover 46 slides rearward into the base member housing 401, the beveled rear face 475 (FIG. 10) of the catch lip 69 thereon fits the front edge of the housing top wall 45, forcing the catch lip 69 downward therebelow and so bending the tab 472 downward to allow the access cover 46 to slide rearward fully into installed relation with the housing 401 wherein, as shown in FIG. 12, the catch lip 69 then springs upward into the retention hole 68 of the housing top wall 45 to retain the access cover 46 fixedly on the housing 401 in front and bottom closing relation therewith and against the accidental forward removal therefrom.

The thus installed access cover 46 both the open bottom and the front of the housing 401 and therewith completes the base member 40 and hides the contents thereof from view. Having both the bottom and the front of the base member housing 401 open eases assembly and adjustment of the spring biasing mechanism 50, 52, 53 by allowing free entry by the assembler's fingers and wrenches of any desired type, and allows the fasteners 14 to be easily driven into the support surface 12 by a tool (e.g. screwdriver) extending into the open front of the base member housing 401. The access cover 46 is easily removable from the housing 401 by depressing the catch lip 69 (as by means of a screwdriver blade or other convenient tool downwardly into the retention hole 68), and to clear the bottom of the retention hole 68, and by means of the user's fingernail, or any convenient tool inserted in the finger notch 489 the access cover 46 can then be moved forwardly out of engagement with the base member housing 401.

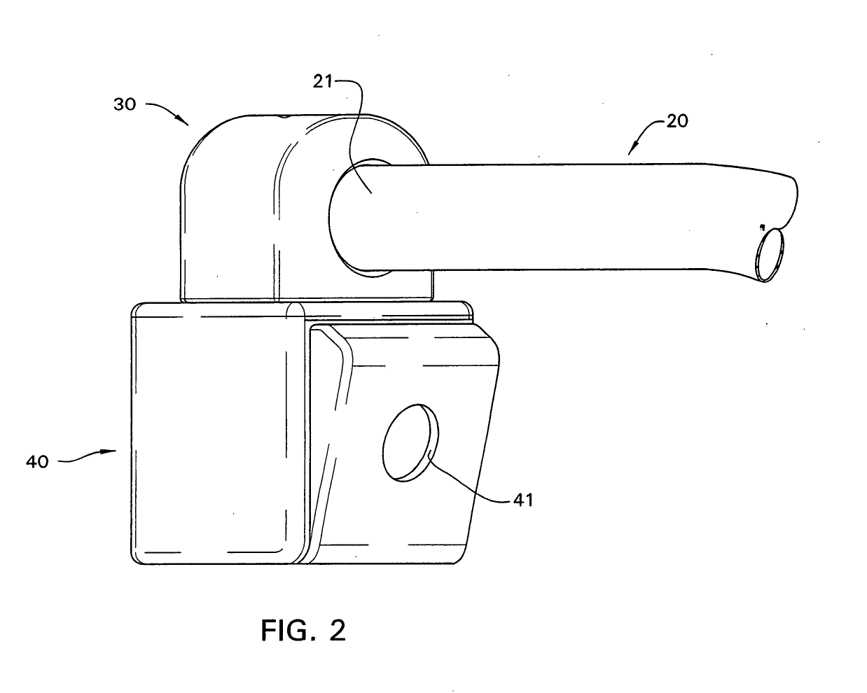

The easy removal of the access cover 46 allows ready access to the nut 53 (FIG. 17) to readjust spring bias and/or to add or source an accessory 70 via an accessory hole 41 (FIGS. 2 and 10) in the front 47 face.

### Operation

The difference in the deep and shallow detents 65 and 66 requires that different forces be applied to the handle 20 to cause the projections 31 to escape from such respective detents 65 and 66 to shift between the stowed and use positions.

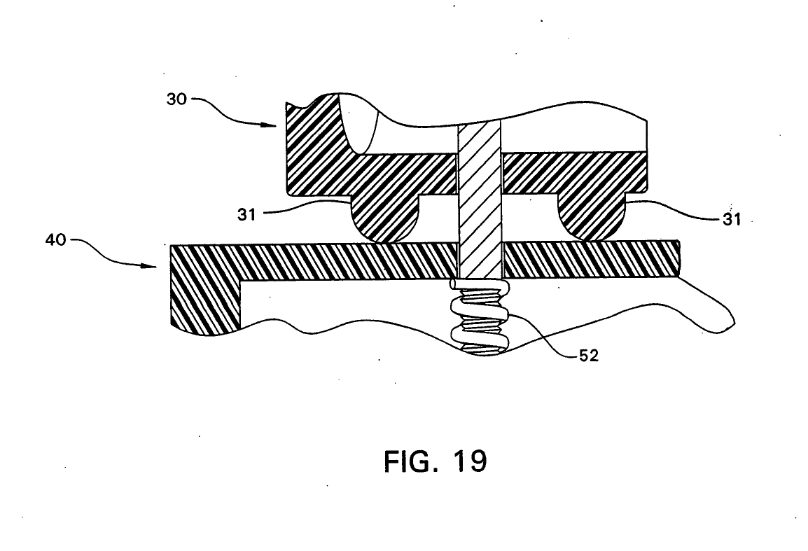

With the handle 20 is in its stowed position (FIG. 18 and in dotted line in FIG. 1A) only the convex bottom portions of the projections 31 rest in the shallow detents 66, and the rotor bottom wall 305 is spaced above the base member 40. Only a modest pulling force on the handle 20 cause the projections 31 to move up and laterally out of the shallow detents 66 and onto the top wall 45 of the base member 40, wherein the rotor 30 is spaced further above the base member 40 (FIG. 19). A lesser pulling force on the handle 20 skids the projections 31 along the top 45 of the base member housing 401 (as in FIG. 19) to pull the handle 20 away from its detented stowed position toward the detented use position (FIG. 17 and in solid line in FIG. 1A). Removing the handle 20 from its stowed position with only a modest force circumferential pull is simpler, more intuitive and easier than with conventional handles that require that the user to first lift the handle and then while still maintaining the lifting force, pulling the handle out of its stowed position.

The shallow hemispheric shape of the shallow (stowed position) detents 66 and hemispheric shape of the ends 35 of the projection 31 requires an initial tug to start camming the projection 31 out therefrom, but a lessening force as the projection 31 exits from the detent 66.

Thus, to pivot the handle from its stowed position, the user applies only a modest lateral pulling force handle, and has no need to both lift upward and pull outward. Thus, the invention enables a very simple unstowing of the assist handle 20 by simply pulling outward away from the support surface 12. This is helpful for persons who have limited mobility or strength, because they need not (as at S in FIG. 1A) lean over from or walk around stairs for purpose of lifting the handle 20 before it can be pulled outwardly away from its support surface 12.

Once in their detented use positions (FIGS. 1, 1A and 17), rotor members 30 orient the handle 20 in a useable position extending outwardly (preferably perpendicularly) away from the support surface 12. There the downward bias force, provided by the spring 52, urges the projections 31 fully into the deep detents 65.

Once there, a simple lateral pull or push on the handle 20 cannot remove it from its detented use position (FIG. 1A in solid lines and FIG. 17) because in the detented use position the entire length, even the cylindrical top portions, of the projections 31 are telescoped, cylindrical wall to cylindrical wall, in the deep detents 65. Thus, the user cannot under foreseeable circumstances exert a sufficient lateral force on the handle 20, accidentally or on purpose, to cause the projections 31 to leave the deep detents 65, or to move the handle 20 out of its detented use position.

To dislodge the projections 31 from the deep detents 65, and remove the handle from its detented use position (FIG. 17) toward its detented stowed position (FIG. 18), the user must first lift the handle to clear the projections 31 from the deep detents 65 and maintain the lift, while laterally pushing the handle 20 away from its use detent position. However, this need to lift the handle is not onerous even for a person of limited mobility or strength, since the handle in its use position is close at hand and can easily be grasped without need to lean over awkwardly from or walk around stairs (S in FIG. 1A).

Outside the bounds of foreseeable, intended usage an extreme lateral force may be applied unintentionally to the handle 20, for example in the event that the handle assembly 10 is mistakenly left in the use position when mounted on the side of a moving vehicle and then comes into contact with a fixed object, such as a telephone pole or building. When such an extreme force is applied, the handle 20 will pop out of the use position and move towards the stowed position despite there having been no upward force applied. This is possible because the base member housing 401, the projections 31 and the surfaces of the deep detents 65 can undergo enough elastic deformation under extreme force conditions to permit slippage between the contacting surfaces of the projections 31 and the deep detents 65.

The handle 20 is stable in its the stowed position, even during travel on a vehicle incorporating the support surface 12, because the bias force of the spring 52 pushes downwardly on the rotor member 30 sufficient to hold the projections 31 in their shallow detents 66.

While the handle is in transit between the two detented positions (use and stowed), the projections 31 of the rotor 30 are not engaged with either the shallow detents 66 (see FIG. 16) or the deep detents 65 (see FIG. 15). The projections 31 remain biased downward against the top wall 45 of the base member 40 by the spring 52 (FIG. 19) as the projections slide between the detents 65, 66.

### Accessories

An added benefit of the invention is that the base member 40 can serve as a useful platform for useful optional accessories. For example, an accessory 70 (FIG. 17) can disposed in access cover 46 at the accessory hole 41 (FIGS. 2 and 10) on the upward and forward sloping portion 477 of its front wall 47. Thus, in FIG. 17, a lamp 70 includes an LED 72 fronted by a lens 74 for providing illumination of handle 20 and the area (e.g. stairs S) near the folding handle assembly 10. Implementation of an LED lamp in conjunction with a handle, including electrical schematics, is disclosed in prior Camarota et al. U.S. Pat. No. 6,592,240 incorporated by reference herein.

Other accessories may be optionally implemented at the accessory hole 41, such as a motion sensor or a doorbell button (not shown). Power or signal carrying wires W needed for a given accessory may be run via a wiring hole 76 through the back wall 42 of the base member 40 and through the supporting surface 12. In the embodiment shown in FIG. 17, such wires connect the LED 72 to a suitable voltage source V through a switch SW.

Alternatively, the voltage source V may be a battery disposed within said access cover and said switch SW may be a switch responsible to manual activation or to ambient light, accessible from outside said base member, when LED actuation is not needed. In that instance, it is convenient to relocate such switch and battery on an interior surface of the battery cover as schematically indicated in dotted line at SB (FIG. 17).

The rotor 30 and base member 40 are preferably of rigid, molded plastics material, preferably of relatively high strength. In one unit constructed according to the invention same were of polycarbonate. Other moldable plastics materials (e.g., 30% glass fiber filled nylon), and even castable metal materials are contemplated but less preferred. The handle 20 on the other hand is preferably of light weight, extruded, bendable metal, such as aluminum.

Alternatively, the accessory hole 41 may be omitted and the flat space on the front wall 47 of the access cover 46 utilized as display space by fixing a niche, bezel, or other equivalent structure to provide a space to display text or graphics.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A swing away assist handle assembly having a use position protruding from, and a stowed position adjacent, a support surface, the assembly comprising:
a support surface mountable base member;
a rotor member pivotally carried by said base member on a pivot axis and having circumferentially spaced stowed and use positions;
a hand graspable handle fixed to and extending from said rotor member;
opposed faces on said base member and rotor member resiliently biased toward each other, said opposed faces extending transversely to and being relatively circumferentially displaceable about said pivot axis;
circumferentially opposed, relatively slideable, camming surfaces on said opposed faces, said camming surfaces being engaged in said stowed position and fixing said handle in said stowed position against circumferential forces less than, but not greater than, a first circumferential force;
circumferentially opposed engagement surfaces on said opposed faces, said engagement surfaces being relatively engaged in said use position and maintaining said handle in said use position against a second circumferential force greater than said first circumferential force.

2. The apparatus of claim 1, in which said opposed faces comprise a base member top wall and a rotor member bottom wall, a pin comprising a substantially cylindrical shank and a convex free end protruding from one of said walls, the other of said walls having circumferentially spaced deep and shallow depressions said camming surfaces comprising circumferentially opposable surfaces of said convex pin end and shallow depression, said circumferentially opposed engagement surfaces comprising circumferentially opposable surfaces of said pin cylindrical shank and said deep depression, said deep and shallow depressions being of diameter to snugly but slideably receive said shank and convex end respectively so as to define circumferentially fixed stowed and use positions of said handle.

3. The apparatus of claim 2, in which said base member comprises a housing having an open front and bottom and a removable access cover having front and bottom walls.

4. The apparatus of claim 3, in which said rotor member, housing and access cover are rigid molded plastics pieces.

5. The apparatus of claim 3, including an electrical accessory on and facing outward from said access cover, said base member housing electrical conductors for energizing connected to said electrical accessory.

6. A folding assist handle assembly for mounting on a support surface, the assembly having a use position protruding from the support surface and a stowed position adjacent the support surface, the assembly comprising:
a base member adapted for mounting on a support surface;
a rotor member resiliently biased toward said base unit and rotatable with respect to said base unit on a pivot axis, one of said base member and rotor having an engagement face with a deep detent and shallow detent, the other of said rotor member and rotor member having a projection extending toward said engagement face, said rotor member having circumferentially spaced use and stowed positions corresponding respectively to engagement of said projection with said deep detent and said shallow detent; and
a handle fixed to and extending from the rotor member.

7. The apparatus of claim 6, in which said projection and shallow detent have camming surfaces maintaining said handle in said stowed position against circumferential forces applied to said handle less than a first circumferential force threshold, said projection and deep detent having corresponding cylindrical surfaces maintaining said handle in said use position against circumferential forces applied to said handle greater than said first circumferential force threshold.

8. The apparatus of claim 6, in which said projection comprises a pin depending from a bottom wall of said rotor member and receivable snugly in a said shallow detent and deep detent, the engagement face comprising a top wall of said base member in which said shallow and deep detents are formed, said deep detent comprising a through hole in said top wall, said shallow depression comprising a substantially hemispherical recessed in said top wall, said pin having a substantially hemispherical free end terminating a substantially cylindrical shank, said shank being extending approximately ¼ the axial length of said pin, said shank being fully received in said hole in said use position, said shank spacing said rotor member and base member in said stowed position.

9. The apparatus of claim 7, in which a top wall of said base member has an upstanding pivot axis therethrough spaced rearward from the front edge thereof, two of said deep detents and two of said shallow detents being equally circumferentially spaced from each other and equally radially spaced from said pivot axis and opening upward in said top wall, said rotor member having a pivot axis coaxial with the pivot axis of said base member, said rotor member having two of said projections equally radially spaced from said rotor pivot axis and depending from the bottom of said rotor member toward said base member top wall, said projections being positioned diametrically opposed across said rotor member pivot axis, said projections being circumferentially located on said rotor member to engage said deep depressions in said use position of said handle and to engage said shallow depressions in said stowed position of said handle.

10. The apparatus of 8, in which a given one of said deep depressions and a given one of said shallow depressions have central axes defining a plane substantially parallel to said base member front and spaced between said base member front edge and said base member pivot axis, the remaining said deep depression and the remaining said shallow depression having central axes defining a plane parallel to said first mentioned plane and spaced an equal distance rearward from said base member pivot axis, said projections having central axes defining a plane extending diagonally with respect to opposed side walls of said rotor member and including the said rotor member pivot axis.

11. The apparatus of claim 6, wherein the first circumferential force threshold is sufficiently small that the handle is moveable from the stowed position by application of circumferential force alone, without application of an upward force.

12. The apparatus of claim 6, wherein the base member comprises a two-sided access cover.

13. The apparatus of claim 6, the assembly further comprising a light mounted to the base member.

14. A folding accessed handle and assembly for mounting on a support surface, the assembly having a use position protruding from the support surface and a stowed position adjacent the support surface, the assembly comprising:
a support surface mountable base member;
a rotor member pivotally carried by said base member on a pivot axis and having circumferentially spaced stowed and use positions;
a hand graspable handle fixed to and extending from said rotor member, said base member having a housing having a back wall fixable to the support surface for locating said rotor member and handle, side walls extending forward from said base member, and a top wall adjacent the top of said back wall and side walls, said base member being open at the front and bottom; and
an access cover having front and bottom walls releasably engageable with said base member in a position closing the open front and bottom sides thereof.

15. The apparatus of claim 14, including fasteners extending through said housing back wall for fastening said base member to an environmental support surface, said fasteners having portions facing forward through the open front of said base member housing for access by a fastener tightening and loosening tool.

16. The apparatus of claim 14, including front-to-back extending, vertically overlapping sliding and guiding structure on said base member side walls and side edges of said access cover bottom wall and releasable snap fit structure on said base member top wall and access cover front wall for fixedly but releasably fixing said access cover on said base member.

17. The apparatus of claim 16, in which said sliding and guiding structure comprises: a channel formed on the inside surface of the housing side walls between a buttress extending forwardly along a housing side wall and a lip projecting inwardly and extending along the bottom edge of the housing side wall, and a flange extending along an edge of the access cover bottom wall.

18. The apparatus of claim 16, in which said base member housing top wall adjacent the front edge thereof has a tool insertion opening in releasing relation with the snap fit structure on the access cover, and said access cover bottom wall adjacent the rear edge thereof includes a rear facing forwardly pushable surface to facilitate forward removal of said access cover from said base member.

19. The apparatus of claim 14, in which said access cover front wall slopes upward from its said bottom wall, is bent near the top thereof to slope upward and rearward and has sidewalls extending rearward to substantially the top and bottom edges of said front wall and forming therewith a shallow rearward facing recess.

20. The apparatus of 19, including a hole through said access cover front wall and an electrically powered accessory device prominent said hole.

21. The apparatus of claim 20, in which said electrical accessory device is selected from the group consisting of a lamp, a motion sensor, and a doorbell.

22. The apparatus of claim 20, in which said electrical accessory device comprises an LED having a light emitting portion facing forward through a hole and including mounting structure and electrical supply structure in said base member and hidden by said access cover.

23. A swing away assist handle assembly having alternative protruding use and stowed positions and adapted for mounting on a support surface, the assembly comprising:
a support surface mountable base member;
a rotor member pivotally carried by said base member on a pivot axis and have circumferentially spaced stowed and use positions;
a hand graspable handle fixed to and extending from said rotor member;
spring biasing structure interposed between said base member and rotor member and urging one toward the other;
detents structure between said base member and rotor member and defining said circumferentially spaced stowed and use positions;
said base member having a face opposing said handle and a hole in said face; and
an electrical accessory disposed in said hole in said face and facing out of said base member.

24. The apparatus of claim 23, in which said electrical accessory is selected from the group consisting of a light, a sensor, and a signaling device.

25. The apparatus of claim 23, in which said electrical accessory comprises a light fixture disposed in said hole and including a LED aimed into a zone occupiable by said handle and including electrical conductors within said base member connecting said LED to an energy source for energizing said LED.

26. The apparatus of claim 1, in which at least one of said base member and said rotor member is distortable upon application to said handle of an extraordinary third circumferential force substantially greater than said second circumferential force to displace said handle from said use position so as to avoid breakage of said base member, said rotor member, and said handle.
